(19) United States
(12) Patent Application Publication
(10) Pub. No.: US 2024/0333755 A1
(43) Pub. Date: Oct. 3, 2024

(54) REACTIVE DOMAIN GENERATION ALGORITHM (DGA) DETECTION

(71) Applicant: Cisco Technology, Inc., San Jose, CA (US)

(72) Inventors: David Rodriguez, Sebastopol, CA (US); Andrea Michelle Kaiser, Boise, ID (US)

(73) Assignee: Cisco Technology, Inc., San Jose, CA (US)

(21) Appl. No.: 18/190,704

(22) Filed: Mar. 27, 2023

(51) Int. Cl. H04L 9/40

(52) U.S. Cl. CPC H04L 63/1441; H04L 63/1425

(57) ABSTRACT

A method of detecting a domain generation algorithm (DGA) may include categorizing a plurality of domain name system (DNS) queries received from a client device based on a perplexity score to obtain a group of categorized DNS queries. The method may further include verifying that the DNS queries correspond to a number of unique qualified names (qnames) or fully quantified domain names (FQDNs) within the group of categorized DNS queries. The method may further include transmitting to a DGA cache a number of entries including an identification of the client device transmitting the DNS queries and a perplexity score, the identification of the client device and the perplexity score defining a family of DNS queries that are produced by the DGA. The method may further include blocking subsequent DNS queries from the client device based on entries within a blocklist.

### TECHNICAL FIELD

The present disclosure relates generally to network security. Specifically, the present disclosure relates to systems and methods for domain generation algorithm (DGA) detection and associated perplexity logic.

### BACKGROUND

A domain name system (DNS) server may be used to map names of objects such as host names or domain names into IP numbers or other resource record values. The DNS server provides a translation from host names to IP addresses, so that applications can effect a network connection from a command. Further, the DNS server maps from IP addresses back to names in order to provide some level of authentication.

A DNS may be subject to a number of attacks or used to enable the communication of botnets. One method of communication of a “Command and Control” (C&C) server to infected hosts is through DNS queries. These queries alert a C&C server to newly infected hosts and tailored software payloads for the infected host to run locally. In an attempt to keep the communication between C&C server and hosts domain generating algorithms (DGAs) enable DNS queries to obfuscate the intent of the DNS traffic. A wide array of domain names are used to try to evade detection from security appliances by using different characters, digits, label lengths and top level domains (TLDs). If successful resolution of a domain occurs, a threat actor may choose to control a host remotely to inflict damage on the wide internet eco-system in the form of DDoS attacks. The threat actor may also choose to stay under the radar and covertly exfiltrate sensitive information from hosts or infiltrate malicious payloads to hosts using the DGA.

A DNS may be subjected to a number of types of network attacks from third parties. One type of network attack includes a denial-of-service (DoS) attack. The goal of a DoS attack is to prevent legitimate use of the services available on the network. For example, a DoS jamming attack may artificially introduce interference into the network, thereby causing collisions with legitimate traffic and preventing message decoding. In another example, a DoS attack may attempt to overwhelm the network's resources by flooding the network with requests, to prevent legitimate requests from being processed. A DoS attack may also be distributed, to conceal the presence of the attack. For example, a distributed DoS (DDoS) attack may involve multiple attackers sending malicious requests, making it more difficult to distinguish when an attack is underway. When viewed in isolation, a particular one of such a request may not appear to be malicious. However, in the aggregate, the requests may overload a resource, thereby impacting legitimate requests sent to the resource.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of a system that utilizes domain generation algorithm (DGA) detection and perplexity logic, according to an example of the principles described herein.

FIG. 2 illustrates a flow diagram of an example method of detecting a domain generation algorithm (DGA), according to an example of the principles described herein.

FIG. 3 illustrates a flow diagram of an example method of detecting a domain generation algorithm (DGA), according to an example of the principles described herein.

FIG. 4 is a component diagram of example components of a DNS server and/or analysis server including DGA resolution services, according to an example of the principles described herein.

FIG. 5 illustrates a computing system diagram illustrating a configuration for a data center that may be utilized to implement aspects of the technologies disclosed herein.

FIG. 6 illustrates a computer architecture diagram showing an example computer hardware architecture for implementing a computing device that may be utilized to implement aspects of the various technologies presented herein.

### DESCRIPTION OF EXAMPLE EMBODIMENTS

### Overview

A method of detecting a domain generation algorithm (DGA) may include categorizing a plurality of domain name system (DNS) queries received from a client device based on a perplexity score to obtain a group of categorized DNS queries. The method may further include verifying that the DNS queries correspond to a number of unique qualified names or are approximately the same as a number of unique qualified domain names (qnames) or fully quantified domain names (FQDNs) within the group of categorized DNS queries. The method may further include transmitting to a DGA cache a number of entries including an identification of the client device transmitting the DNS queries and a perplexity score, the identification of the client device and the perplexity score defining a family of DNS queries that are produced by the DGA. The method may further include blocking subsequent DNS queries from the client device based on entries within a blocklist.

### EXAMPLE EMBODIMENTS

Attackers of a network infrastructure may have as a goal to maintain command and control (C2) communications between infected computing devices. Domain generation algorithms (DGAs) are algorithms seen in various families of malware that are used to generate a large number of domains to which malware may possibly connect. This makes it difficult for reputation-based systems to keep up with the large volume of C2 communications. Leveraging a high volume of algorithmically-generated domains may improve the robustness of the attacker's infrastructure. In fact, domains provide attackers with advantages over internet protocols (IPs), which is why over 90% of malware use DNS to initiate C2 communications and issues DNS requests as a first step in C2 communication. In addition to including mathematical expressions, DGA may include multiple features that make them more robust. For example, the DGA may include static configurations such as, for example, a sequence of numbers and/or characters using dates and times as a base. The DGA may utilize a seed or a static configuration (e.g., hard-coded element) and an initial or starting domain such as, for example, www.[gibberish].com where “[gibberish]” is any sequence of numbers and/or characters. As the DGA executes C2 communications, it may load the configuration and the starting domain. The result of the DGA executing, a new domain is obtained such as www.[gibberish2].com. In most instances, the DNS may respond with an non-existent domain (NXDOMAIN) response message; a DNS message type received by a DNS resolver when a request to resolve a domain is sent to the DNS and cannot be resolved to an IP address. This process may repeat any number of times until the DGA hits on a live and unblocked domain and the DNS returns a valid IP address through which C2 communication may commence. This may lead to the malware infiltrating the network, infecting other devices, and gaining access to private or proprietary information.

In some instances, the DGA may be reversed engineered in order to reject any DNS requests that fit the outcome of the DGA. However, addressing DGAs in this manner requires access to either malware samples, code samples, or every iteration of possible qnames. Further, this and other solutions do not have the ability to address a previously unknown DGA attack in real time leading to reliance on the DGA being active for at least a certain period of time needed to acquire samples and logs.

Thus, DGAs continue to be used in C2 communication because of their endless number of variations and difficulty to detect; especially in instances where small modifications to an existing DGA is used. In some DNS resolution products and services such as, for example, Cisco Umbrella®, a blocklist of DGA domains may be transmitted to the DNS resolver(s) to block DNS queries. However, such blocklists requires DGAs to be identified prior to use. Further, the blocklist solution does not account for all variants of a DGA that are extremely difficult to find or know. Further, even if the DNS resolver was aware of all variants, the DNS resolver has a finite amount of memory, and, thus, cannot store all variants. Thus, there is a need for systems and methods that identify malicious DGAs with high precision, in real time, and as fast as possible.

Thus, the present system and methods provide for real time detection of DGAs in a DNS resolver and may be referred to as reactive DGA detection because a state is maintained in a stream of DNS query events, and when a threshold number of events subsequently occur, future DGA queries are detected and blocked. Upon studying of a myriad of DGA variants from DGA archives and self-curating feeds such as Bambenek Labs® DGA feeds, three observations may be made. First, DGAs, in many instances, may be identified by their unique lexical characteristics. An exception may include if, for example, a word-based DGA is used. Second, the query behavior of a DGA from a client device exhibits a trademark number of NXDOMAIN queries in succession, though this may occur at varying time intervals. Third, depending on the DGA, the number of qnames queried by a client device may cycle after an arbitrary number of qnames.

In the examples described herein, the present systems and methods provide for DGA detection that concisely identifies all these characteristics in a fast, scalable manner, and which may be embedded in a DNS resolver with little overall impact to the requirements of the DNS resolver service level agreements (SLAs). More details of the present systems and methods are provided herein, but as an overview, the DNS resolver may include hardware and/or software to isolate client device IP sessions of NXDOMAIN queries and group the NXDOMAIN queries together that have similar “perplexity,” qname shape (e.g., number of labels and size of DNS labels), and public suffixes to create families of queries. By grouping domains with similar perplexity (e.g., those that have a perplexity score of approximately +/−10), approximately similar strings of characters such as “vg4klqj4f2q” and “mbtin2mqbo3” (e.g., www.[gibberish].com) may be grouped together. The groups or families may be restricted to the same qname shape since some DGA algorithms vary string lengths, and later compensate by reducing threshold values as low as possible when identifying DGA events. Similarly, based on research, some DGAs may cycle through usually no more than approximately five public suffixes, and the present systems and methods may compensate in later iterations by attempting to reduce threshold values as low as possible.

After a threshold number of NXDOMAIN queries per client are counted in a cache (e.g., approximately 3 to 30 queries), the systems and methods may verify that the number of queries is roughly the same as the number of unique qnames. For example, the client device may be cycling through a list of qnames that are unique and not retrying any previously-requested qnames. The client device along with the qname shape and perplexity score may be sent to a real-time blocklist cache and subsequent queries may be blocked some of which may not be NXDOMAIN queries. This provides for the ability to block resolving C2 communication from the DGA.

Throughout the present specification the terms request and query as in DNS request and DNS query are used interchangeably and as used in the present specification and in the appended claims, are meant to be understood broadly as any message sent by a client device to a DNS server.

Examples described herein provide a method of detecting a domain generation algorithm (DGA), and may include categorizing a plurality of domain name system (DNS) queries received from a client device based on a perplexity score to obtain a group of categorized DNS queries, and verifying that the DNS queries correspond to a number of unique qualified names (qnames) or are approximately the same as a number of unique qualified names within the group of categorized DNS queries. The method may further include transmitting to a DGA cache a number of entries may include an identification of the client device transmitting the DNS queries and a perplexity score, the identification of the client device and the perplexity score defining a family of DNS queries that are produced by the DGA, and blocking subsequent DNS queries from the client device based on entries within a blocklist.

The perplexity score of a string of characters within a domain name of a first DNS query of the plurality of DNS queries is computed based at least in part on a Markov model comparing two characters of the string of characters to another character of the string of characters. The plurality of DNS queries within the family of DNS queries include the perplexity score within a threshold range of at least one other DNS query within the family of DNS queries.

The method may further include storing within a main cache of a DNS server domain names of the plurality of DNS queries and DNS query responses associated with the plurality of DNS queries. The transmitting to the DGA cache the number of entries may include the identification of the client device transmitting the DNS queries and the perplexity score and may further includes storing within the DGA cache, a plurality of vectors defining the perplexity score of the categorized DNS queries, incrementing a counter for each of the DNS queries identified as belonging within the family of DNS queries, and transmitting a notification based on the counter exceeding a family member threshold.

The method may further include, with a real-time blocklist (RBL) cache, storing a number of blocklisted client devices based on the number of entries of the DGA cache to form the blocklist. The blocking of the subsequent DNS queries from the client device may include accessing the entries within the RBL cache, and blocking the subsequent DNS queries based on an existence of the entries within the RBL cache. The blocking of the subsequent DNS queries may include blocking the subsequent DNS queries that fall within the family of DNS queries. The categorizing of the plurality of DNS queries received from the client device based on the perplexity score may include grouping a number of domains with the perplexity score of, for example, +/−10, grouping the number of domains with a same qname shape, grouping the number of domains with a same top-level domain (TLD), grouping the number of domains with a same time period in between them, and combinations thereof.

Examples described herein also provide a non-transitory computer-readable medium storing instructions that, when executed, causes a processor to perform operations, may include categorizing a plurality of DNS queries received from a client device based on a perplexity score to obtain a group of categorized DNS queries, and verifying that the DNS queries correspond to a number of unique qualified names (qnames) are approximately the same as a number of unique qualified names within the group of categorized DNS queries. The operations may further include transmitting to a DGA cache a number of entries may include an identification of the client device transmitting the DNS queries and a perplexity score, the identification of the client device and the perplexity score defining a family of DNS queries that are produced by the DGA, and blocking subsequent DNS queries from the client device based on entries within a blocklist.

The perplexity score of a string of characters within a domain name of a first DNS query of the plurality of DNS queries is computed based at least in part on a Markov model comparing two characters of the string of characters to another character of the string of characters. The plurality of DNS queries within the family of DNS queries include the perplexity score within a threshold range of at least one other DNS query within the family of DNS queries.

The operations may further include storing within a main cache of a DNS server domain names of the plurality of DNS queries and DNS query responses associated with the plurality of DNS queries. Transmitting to the DGA cache the number of entries including the identification of the client device transmitting the DNS queries and the perplexity score may further include storing within the DGA cache, a plurality of vectors defining the perplexity score of the categorized DNS queries, incrementing a counter for each of the DNS queries identified as belonging within the family of DNS queries, and transmitting a notification based on the counter exceeding a family member threshold.

The operations may further include, with a real-time blocklist (RBL) cache, storing a number of blocklisted client devices based on the entries of the DGA cache to form the blocklist. The blocking of the subsequent DNS queries from the client device may include accessing the entries within the RBL cache, and blocking the subsequent DNS queries based on an existence of the entries within the RBL cache. The blocking of the subsequent DNS queries includes blocking subsequent DNS queries that fall within the family of DNS queries. The categorizing of the plurality of DNS queries received from the client device based on the perplexity score includes grouping a number of domains with the perplexity score of, for example, +/−10, grouping the number of domains with a same qname shape, grouping the number of domains with a same top-level domain (TLD), grouping the number of domains with a same time period in between them, and combinations thereof.

Examples described herein also provide a system may include a processor, and a non-transitory computer-readable media storing instructions that, when executed by the processor, causes the processor to perform operations. The operations may include categorizing a plurality of DNS queries received from a client device based on a score to obtain a group of categorized DNS queries, and verifying that the DNS queries correspond to a number of unique qualified names (qnames) are approximately the same as a number of unique qualified names within the group of categorized DNS queries. The operations may further include transmitting to a DGA cache a number of entries may include an identification of the client device transmitting the DNS queries and a perplexity score, the identification of the client device and the perplexity score defining a family of DNS queries that are produced by the DGA, and blocking subsequent DNS queries from the client device based on entries within a blocklist.

The perplexity score of a string of characters within a domain name of a first DNS query of the plurality of DNS queries may be computed based at least in part on a Markov model comparing two characters of the string of characters to another character of the string of characters. The plurality of DNS queries within the family of DNS queries include the perplexity score within a threshold range of at least one other DNS query within the family of DNS queries. The operations may further include storing within a main cache of a DNS server domain names of the plurality of DNS queries and DNS query responses associated with the plurality of DNS queries. Transmitting to the DGA cache the number of entries including the identification of the client device transmitting the DNS queries and the perplexity score may further include storing within the DGA cache, a plurality of vectors defining the perplexity score of the categorized DNS queries, incrementing a counter for each of the DNS queries identified as belonging within the family of DNS queries, and transmitting a notification based on the counter exceeding a family member threshold.

The operations may further include, with a real-time blocklist (RBL) cache, storing a number of blocklisted client devices based on the entries of the DGA cache to form the blocklist. The blocking of the subsequent DNS queries from the client device may include accessing the entries within the RBL cache, blocking the subsequent DNS queries based on an existence of the entries within the RBL cache. The categorizing of the plurality of DNS queries received from the client device based on the perplexity score includes grouping a number of domains with the perplexity score of, for example, +/−10, grouping the number of domains with a same qname shape, grouping the number of domains with a same top-level domain (TLD), grouping the number of domains with a same time period in between them, and combinations thereof.

Additionally, the techniques described in this disclosure may be performed as a method and/or by a system having non-transitory computer-readable media storing computer-executable instructions that, when executed by one or more processors, performs the techniques described above.

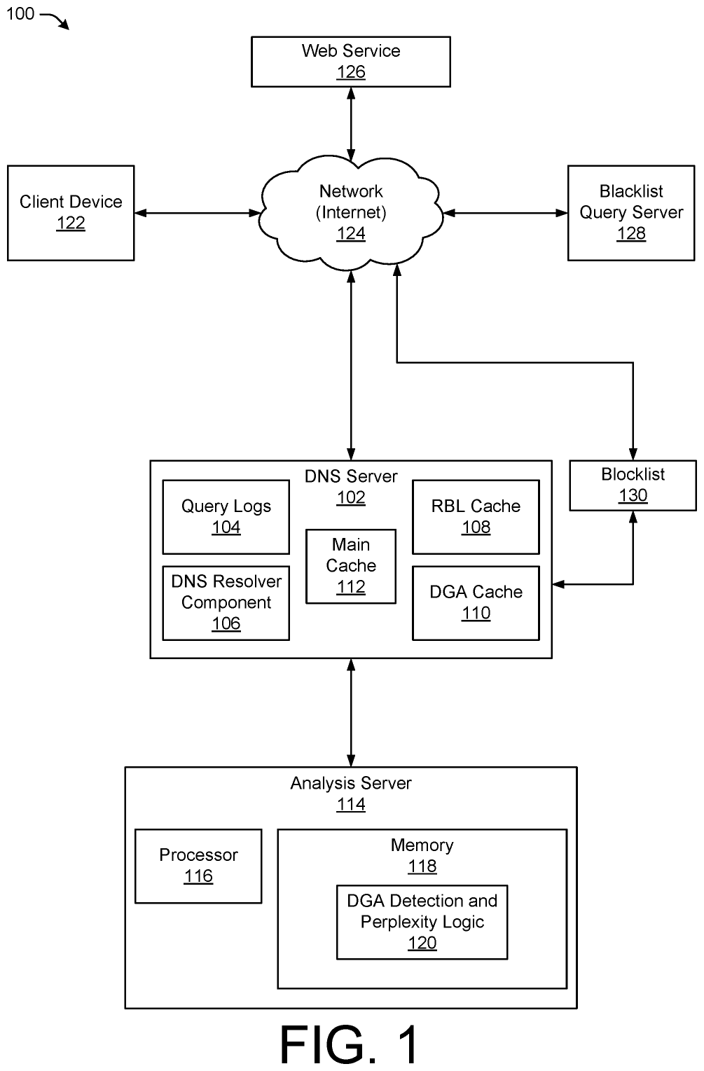

Turning now to the figures, FIG. 1 illustrates a system-architecture diagram of a system 100 that utilizes domain generation algorithm (DGA) detection and perplexity logic, according to an example of the principles described herein. A network 124, such as the Internet, interconnects an client device 122, a (e.g., 3^{rd} party) blacklist query server 128, a web service 126, and a DNS server 102. FIG. 1 may be a simplified diagram showing only one of each network connected device. However, any number of DNS servers 102 may operate in a distributed manner, and there may be hundreds or thousands of instances of client devices 122, blacklist query servers 128, and web services 126.

The DNS server 102 may be employed to, among other things, resolve unique qualified names (qnames) or fully quantified domain names (FQDNs) to an IP address. For example, a browser application running on the client device 122 (e.g., a computer) may receive input from a user when the user selects a link on a webpage. The link is associated with content or services that are desired to be accessed by the user, but the content or services may be stored on a remote server such as a server associated with or supporting the web service 126. In order for the browser to obtain the content or services from the remote server, the browser must first obtain an IP address of the remote server. In this regard, the browser sends to the DNS server 102 a DNS request seeking an IP address corresponding to the domain name of the remote server. The corresponding IP address may be returned to the browser (i.e., client device 122) by the DNS server 102 in a DNS response. In one example, the DNS server 102 is a recursive DNS server. Further, in one example, the DNS server 102 may be provided as-a-service (aaS) such as, for example, software-as-a-service (SaaS) and other aaS offerings.

The DNS server 102, however, does not just process DNS requests from browsers. An email server or firewall operating in the instant case as the client device 122) may also be interested in knowing the reputation of a given domain from which a communication has arrived, or to which, for example, an embedded link in an email may be pointing to. In this example, a blacklist query server 128, reachable via a given domain name (or domain reputation API), may be employed by such an email server or firewall. In one example, a nested DNS request where a portion of a DNS query is generated by the client device 122 (email server, firewall, etc.) that includes the domain name of the blacklist query server 128 (e.g., “bl.blacklist.com”) as a higher level domain and, prepended thereto, the domain name (e.g., “SuspiciousDomain.com”), as a lower level domain. The lower level domain name may be the domain name that the client device 122 may like to confirm is not on a blacklist hosted by the blacklist query server 128 that is reachable via “bl.blacklist.com.” The portion of the DNS query may be forwarded to the DNS server 102 where the IP address for the higher level domain may be resolved to an IP address, which is returned to the client device 122. The client device 122 may then query the blacklist query server 128 using the provided IP address. Such a DNS request may provide insight into how a given client device 122 is behaving and, by extension, it can be determined, by analyzing multiple DNS requests, whether, and how often, domain names are being looked up on domain reputation services, such as the blacklist query server 128. In one example, the blacklist query server 128 may include a number of DGA archives and self-curating feeds such as Bambenek Labs® DGA feeds.

Referring again to FIG. 1, the DNS server 102 may capture and/or store query logs 104 of DNS requests sent by the client device 122. The query logs 104 may cover hours, days, weeks, or months of collected DNS request data from one or more client devices 122, identified via respective IP source addresses. In one example, the query logs 104 may be analyzed to identify and predict whether given domains should be considered suspicious, malicious, etc., and, thus, likely sourced from a DGA. Specifically, an analysis server 114 depicted in FIG. 1 may include a processor 116 and memory 118. The memory 118 may store logic instructions for DGA detection and perplexity logic 120. In one example, the functionality, hardware, and/or software associated with the analysis server 114, the processor 116, the memory 118, and the DGA detection and perplexity logic 120 may be included within the DNS resolver component 106. However, the analysis server 114 and its elements are depicted in FIG. 1 as separate elements for ease of description.

As described in more detail herein, the DGA detection and perplexity logic 120 may be configured to parse a number of received DNS queries to identify which DNS queries are generated by a DGA, group those identified DNS queries and, in real time, block resolving C2 communications from the client device. This may all be based on a perplexity score calculated for each DNS query and/or any number of additional metrics or parameters of a given DNS query. Once a DNS query is identified as being generated by a DGA, any future DNS queries that a grouped into the same family may be placed in a blocklist 130 and/or be disseminated to other network security devices.

The DNS server 102 and analysis server 114 may be implemented in the same hardware devices or in separate hardware devices as depicted in FIG. 1. In addition to the query logs 104, the DNS server 102 may further include a DNS resolver component 106, a main cache 112, a real-time blocklist (RBL) cache 108, and a DGA cache 110. In one example, the DNS resolver component 106 may include any combination of hardware and/or software that causes transformation or resolution of a DNS name (e.g., a domain name) into an IP address and/or perform reverse name resolution including the transformation or resolution of an IP address to a DNS name (e.g., a domain name). Stated another way, the DNS resolver component 106 may receive DNS queries from web browsers and other applications. The DNS resolver component 106 receives a domain names such as, for example, www.example.com and is responsible for tracking down the IP address for that domain name. The DNS resolver component 106 may be operated by a local network, an Internet service provider (ISP), a mobile carrier, a Wi-Fi network, or other third party device or service. The DNS resolver component 106 may begin by looking in one or more of the local resources including the query logs 104, the DNS resolver component 106, the main cache 112, the RBL cache 108, or the DGA cache 110, and if the domain name is found, it is resolved immediately. If not found, the DNS resolver component 106 may contact a DNS root server and receive details of a top level domain (TLD) name server. Via the TLD name server, the DNS resolver component 106 receives details of an authoritative name server, and asks the authoritative name server for the IP that matches the requested domain name. When the DNS resolver component 106 receives the IP, and the query is resolved.

The main cache 112 may be used to store DNS server domain names of a plurality of DNS queries and DNS query responses associated with the plurality of DNS queries. The main cache 112 may be referred to as a DNS cache or as a DNS resolver cache. The main cache 112 may serve as a temporary DNS storage on the DNS server 102 or other device that contains DNS records of already visited domain names (e.g., IPv4 addresses, IPv6 addresses, etc.). The main cache 112 may retain records depending on a time-to-live (TTL) value. In one example, the TTL value may include approximately 15 minutes. However, the TTL value may include any time value including seconds, minutes, days months, etc., and may be user defined. Each time a domain name is queried, the domain may be saved inside the temporary database of records that is the main cache 112 to facilitate a later revisit. The main cache 112 may provide a means by which effort and time may be saved by skipping a long DNS lookup by answering a DNS query with a DNS record that is already inside the temporary main cache 112.

The RBL cache 108 may be used to, at least temporarily, store a number of blocklisted client device(s) 122 and/or DNS queries from the client device(s) 122 based on the number of entries of the DGA cache 110 to form a blocklist. The blocklist may include any access control mechanism that allows through all DNS queries except those explicitly included within the RBL cache 108 which are denied access. The blocking of client device(s) 122 and/or subsequent DNS queries transmitted from the client device 122 may include accessing the entries within the RBL cache 108 and blocking the subsequent DNS queries based on an existence of the entries within the RBL cache. In one example, the RBL cache 108 may include a least recently used (LRU) cache wherein entries in the RBL cache 108 that are least recently used are discarded or otherwise deleted from the RBL cache 108. Stated another way, the LRU cache may include a buffer-like array that evicts entries that are least recently used in instances where a new entry is to be added and the RBL cache 108 is full. The RBL cache 108 may include any algorithm that requires keeping track of what entries were used when and discards the least recently used item.

The RBL cache 108 may include a number of entries that define the vectors or keys that are to be blocked based on the above-described systems and methods. The RBL cache 108 may be checked against any inbound DNS query to determine if that DNS query should be blocked. Blocking of the DNS query may occur before any DNS resolving process occurs. The vectors stored within the RBL cache 108 may be translated as bytes of data so that large amounts of data storage are not necessary to store this information. In one example, the bytes that define the vectors may be serialized and deserialized as numbers, and these numbers have size dimensions as described below.

The RBL cache 108 may include a number of fields for each entry stored therein including a key field and a data filed that form a key/value pair. The key field may include a label size, a client, a public suffix, and a perplexity bucket of the root domain label. The label size field may be stored as an 8 byte array of unsigned integers (e.g., an uint8 array). The client field may include an identification of the client device 122 in the form of a user-defined data type such as structure with a structure size defined in bytes. The public suffix field, like the label size field may be stored as an 8 byte array of unsigned integers (e.g., an uint8 array) and may define the public suffix or TLD of the associated domain name of the DNS query. The perplexity bucket filed defines which perplexity bucket the entry fits into based on the processes described herein. The data field includes the values for the keys found in the key field and may be stored as, for example, a 64 byte array of unsigned integers (e.g., an uint64 array).

In order for the RBL cache 108 to interact with the DNS server 102, the DNS resolver component 106, and/or the DGA detection and perplexity logic 120 of the analysis server 114, the RBL cache 108 may include a number of operations including update, get, and delete that may be utilized in order to access (e.g., get) data stored in the RBL cache 108, update the data stored in the RBL cache 108, and delete data stored in the RBL cache 108. The delete operation may include a TTL value that allows entries to be deleted once the TTL value is obtained for that entry. As described above, the TTL value may be based on an LRU caching strategy wherein entries in the RBL cache 108 that are least recently used are discarded or otherwise deleted from the RBL cache 108. In one example, the TTL may be, for example, approximately between 10 and 20 minutes. In one example, the TTL values of the RBL cache 108 may be set based on values permitted or required in request for comments (RFCs) associated with the DNS server 102 and/or the DNS resolver component 106 that defines how long records may exist in the RBL cache 108 or within the DNS server 102.

The update operation employed in the RBL cache 108 may include a union block in which the memory for the union is equal to the size of its largest member in order to save memory space within the RBL cache 108. Further, the update operation may use bit fields to store categories of data in order to further conserve memory.

The get operation employed in the RBL cache 108 may include a hash lookup process. The hash lookup may include a hash table or a hash map to serve as an abstract data type that maps keys to values. The hash table may use a hash function to compute a hash code into an array of buckets or slots from which the desired value may be found. During the lookup process, the key may be hashed and the resulting hash indicates where the corresponding value is located in the memory of the RBL cache 108. In this manner, data from the RBL cache 108 may be obtained by the DNS resolver component 106, the DGA detection and perplexity logic 120 and other hardware and software of the system 100.

The DGA cache 110 may be used to, at least temporarily, store a number of entries including an identification of the client device 122 transmitting the DNS queries and a perplexity score. In one example, the DGA cache 110 may store this information for approximately 15 minutes and as entries are added to the DGA cache 110, other entries may be removed using a first-in-first-out (FIFO) caching strategy, or an LRU caching strategy, among a myriad of other caching strategies. The identification of the client device 122 and the perplexity score may define a family of DNS queries that are produced by a DGA. The DGA cache 110 may store a plurality of vectors defining the perplexity score of the categorized DNS queries. Further, the DGA cache 110 may include a counter for each of the DNS queries identified as belonging within the family of DNS queries. The counter may be incremented every time a DNS query is identified as belonging to a family. This allows the DNS server 102 to identify instances when a DGA is operating. In one example, the DGA cache may transmit a notification to the DNS server 102 based on the counter exceeding a family member threshold indicating that the members of that family of DNS queries were generated by a DGA and indicating that any subsequent DNS queries that indicate they belong in that family of DNS queries may be discarded as having come from a DGA. With this information, the DNS server 102 may include the family of DNS queries or other information identifying any subsequent DNS query as belonging to that family of DNS queries to the blocklist 130 to allow for the blocking of the client device 122 from which the family of DNS queries originated and/or blocking subsequent DNS queries that qualify as members of the family of DNS queries. In one example, the information stored in the DGA cache 110 may also be stored in the blocklist 130. In one example, the blocklist 130 may be incorporated with the DGA cache 110.

In a manner similar to the RBL cache 108, the DGA cache 110 may include a number of fields for each entry stored therein including a key field and a data filed that form a key/value pair. The key field may include a label size, a client, a public suffix, and a perplexity bucket of the root domain label. The label size field may be stored as an 8 byte array of unsigned integers (e.g., an uint8 array). The client field may include an identification of the client device 122 in the form of a user-defined data type such as structure with a structure size defined in bytes. The public suffix field, like the label size field may be stored as an 8 byte array of unsigned integers (e.g., an uint8 array) and may define the public suffix or TLD of the associated domain name of the DNS query. The perplexity bucket filed defines which perplexity bucket the entry fits into based on the processes described herein.

The data field of the DGA cache 110 may include count values and a qname hash fingerprint. The data field of the DGA cache 110 may include values for the keys found in the key field. The count filed of the data field of the DGA cache 110 may define a number of counts associated with the calculation of the perplexity and vectors as described herein. The counts may include, for example, a threshold number of NXDOMAIN queries per client are counted in a cache (e.g., approximately 3 to 30 DNS queries), a number of DNS queries and associated number of unique qnames, and other data stored in the DGA cache 110 for which incremental counting may be used. The qname hash fingerprint may include any hash process or algorithm that produces the hash of an object's bytes. In one example, the hash algorithm may include the Murmurhash32 (yielding a 32-bit or 128-bit hash values), XXH3 (yielding a 32-bit, 64 bit, or 128-bit hash values), or other non-cryptographic hash functions suitable for general hash-based lookup, to int32, int64, etc. Subsequently, the integer may be mod'd by K (an unsigned integer), which may be used to shift one bit as in (1<<k). In the present description, this may be referred to as a fingerprint or a kth bit fingerprint. In one example, a hash of the IP address (e.g., via murmurhash32) may be processed to obtain a 32 bit random integer to create a value pair of client IDs (e.g., [1234, 6543]) that indicates that two separate client devices are running the same DGA (e.g., are infected with the same DGA). Thus, the algorithm may be selectively turned on or off if it is found that too many users are infected by the DGA, and the algorithm may be turned on only if there are, for example, five or less unique client ID pairs.

In order for the DGA cache 110 to interact with the DNS server 102, the DNS resolver component 106, and/or the DGA detection and perplexity logic 120 of the analysis server 114, the DGA cache 110 may include a number of operations including update, get, and delete that may be utilized in order to access (e.g., get) data stored in the DGA cache 110, update the data stored in the DGA cache 110, and delete data stored in the DGA cache 110. The delete operation may include a TTL value that allows entries to be deleted once the TTL value is obtained for that entry. As described above, the TTL value may be based on an LRU caching strategy wherein entries in the DGA cache 110 that are least recently used are discarded or otherwise deleted from the DGA cache 110. In one example, the TTL may be, for example, approximately between 10 and 20 minutes. In one example, the TTL values of the DGA cache 110 may be set based on values permitted or required in request for comments (RFCs) associated with the DNS server 102 and/or the DNS resolver component 106 that defines how long records may exist in the DGA cache 110 or within the DNS server 102.

The update operation employed in the DGA cache 110 may include the values of the sum count and/or qname fingerprint described above in the key field of the DGA cache 110. The get operation employed in the DGA cache 110 may include the hash lookup process described above in connection with the data field of the DGA cache 110. The hash lookup may include a hash table or a hash map to serve as an abstract data type that maps keys to values. The hash table may use a hash function to compute a hash code into an array of buckets or slots from which the desired value may be found. During the lookup process, the key may be hashed and the resulting hash indicates where the corresponding value is located in the memory of the DGA cache 110. In this manner, data from the DGA cache 110 may be obtained by the DNS resolver component 106, the DGA detection and perplexity logic 120 and other hardware and software of the system 100.

To further illustrate the manner in which the system of FIG. 1 functions, an example will now be provided. In one example, the client device 122 may be infected with malware that causes a plurality of DGA-generated DNS queries to be transmitted from the client device 122 to the DNS server 102 via the network (e.g., Internet) 124. The DGA acting as a form of malware included on the client device 122 may begin to make a number of malicious DNS queries to the DNS server 102. In one example, the DGA, acting as malware, may utilize a seed, a random number generator, an offset, a modifier, and other DGA coding strategies to generate the DNS queries.

The DNS server 102 acts as the C2 communication server and may transmit commands to the client device 122 in the case of both bona fide DNS queries as well as those DNS queries made via the DGA. The DGA may utilize any command-line tool such as client URL (cURL), dig, and others for querying the DNS server 102. The DGA may generate a number of likely unresolving domain names such as, for example, those listed in Table 1:

TABLE 1
Example DGA-generated domain names and responses

| Domain Name | Response |
|---|---|
| kdlsghdakjgfskdh.com | NXDOMAIN |
| lsdkfjggasldkfjjgs.com | NXDOMAIN |
| ienffoakwitnvuys.com | NXDOMAIN |
| . . . | . . . |
| nciisdoejehanqpsl.com | NXDOMAIN |

Although only four domain names are listed in Table 1, in practice, hundreds of thousands of DNS requests may be generated by the DGA per day. Also, in one example, the DGA may create what looks like a randomly generated set of numbers or letters as depicted in Table 1 by utilizing a seed and a random number/letter generator, and including TLD suffix (e.g., .com or .org) to form the domain names.

The DNS server 102 is incapable of storing large amounts of data including the hundreds of thousands of DNS requests generated by the DGA per day. For example, in Table 1 above, the DGA may generate X^{(length of the characters in domain name}, where X is the number of available characters for use in domain name creation (e.g., the ASCII character encoding standard). The DGA may include code that calls for more or fewer available characters as well as the number of characters within the domain name. This amount of data would be untenable; especially since the DNS server 102 does not function as a bulk storage device but instead includes caches as described herein. Further, this character adjustment is what may allow a DGA to evolve and continue to function despite its original algorithm having been reversed engineered and blocked, for example.

In Table 1, all the domain names are unresolvable meaning that the domain name does not exist. A non-existent domain (NXDOMAIN) response may be received by the DNS server 102 after performing a DNS query via the network 124. The DNS queries that return the NXDOMAIN response may be referred to herein as NXDOMAIN queries. These NXDOMAIN queries or the existence of these NXDOMAIN queries may be stored in the query logs 104. In an NXDOMAIN response, the DNS resolver component 106 may respond with an acknowledgement that it recognizes the TLD, but nothing more.

For the above reasons, the above systems and methods utilize the main cache 112, the RBL cache 108, and the DGA cache 110 of the DNS server 102 along with the DGA detection and perplexity logic 120 executed by the analysis server 114 to detect the DNS queries that result in the NXDOMAIN responses, group these DNS queries/NXDOMAIN responses into families, and block subsequent DNS queries/NXDOMAIN responses that qualify as belonging to that family. In order to do this, the DNS server 102 may store in the main cache 112 data related to DNS queries received by the DNS server 102 and resolved using the DNS resolver component 106 including, for example, DNS server domain names of a plurality of DNS queries and DNS query responses associated with the plurality of DNS queries. The DNS server 102 may then instruct the analysis server 114 to execute the DGA detection and perplexity logic 120 and analyze the data stored in the main cache 112.

The DGA detection and perplexity logic 120 may utilize the calculation of a perplexity score to, at least in part, determine the groups or families of the DNS queries/NXDOMAIN responses. The “perplexity” of a domain name identified in the DNS queries may be calculated as to, for example, a domain name. For example, the first entry in Table 1 above is “kdlsghdakjgfskdh.com” and the portion to be analyzed may include the second level domain or subdomain of the TLD. Therefore, in this example, the portion that is to be analyzed with respect to its perplexity may include “kdlsghdakjgfskdh.” The perplexity of this string of numbers, characters, symbols, etc. may be computed as follows:

$$\frac{1}{n - 1} {\sum }_{i = 0}^{n - 1} ( log {p}_{i} - log {p}_{i} ( i + 1 ) ) \qquad Eq . 1$$

where if a string of, for example, “abcd” is written as an array [a, b, c, d] then pᵢ is the number of times character i in the array appears in a sample of document of characters (e.g., the ASCII character encoding standard, the Lorem ipsum text, etc.). Similarly, pᵢ(i+1) is the number of times the two characters pᵢ and pᵢ₊₁ appear adjacent to each other in a document. In one example, the perplexity score may be calculated by utilizing a two-step Markov model to compare two characters within the second level domain (e.g., “kdlsghdakjgfskdh”) of the domain name (e.g., kdlsghdakjgfskdh.com) to one character within the second level domain. In one example, this may include determining a conditional probability where the probability of identifying a first character increases or decreases a probability of a second character following or proceeding that first character. For example, if the first character is “q,” this character may be most often followed by, for example, “u.” Similarly, it may be determined, for example, what characters may most often proceed “q” such as, for example, the character “a.” Once calculated, the perplexity score of a given domain name associated with a DNS query/NXDOMAIN response may be stored in, for example, the DGA cache 110.

Eq. 1 provides a perplexity score assigned to a particular second level domain (e.g., “kdlsghdakjgfskdh”) of the domain name (e.g., kdlsghdakjgfskdh.com). This calculation may be performed for a series of domain names stored in the main cache 112 and grouped into a number of perplexity buckets. A perplexity bucket may be defined as, given a perplexity score k, the perplexity bucket is an integer representing the region that bounds the value k from a sequence of increasing bounds. For example, Perplexity bucket 1 may include perplexity values of 0 through 10 with 0 being inclusive (e.g., [0, 10)), perplexity bucket 2 may include perplexity values of 10 through 20 with 10 being inclusive (e.g., [10, 20)), and so on. Thus, for example, a perplexity score of 6 would map to bucket 1 whereas a perplexity score of 14 would map to bucket 2, etc. The perplexity buckets may be utilized to separate domain names into groups or families for identification as being generated by the same DGA.

With the perplexity as described above and using the domain names of Table 1, an example of how a perplexity score is calculated and assigned to a domain name may include the DGA detection and perplexity logic 120 acknowledging that each of the domain names in Table 1 include a string of 16 characters. This information may be used as a first parameter as to whether a given domain name fits into a family of domain names that may be generated by the DGA.

A second parameter the DGA detection and perplexity logic 120 may determine may include a time interval between receipt of the DNS queries/NXDOMAIN responses such as, for example, receipt of the DNS queries/NXDOMAIN responses into the main cache 112. In one example, it may be determined that a next 16 character domain name related to a first DNS query/NXDOMAIN response was received 3 seconds after a previous 16 character domain name related to a second DNS query/NXDOMAIN response. Thus, a 3 second interval may be determined as another parameter.

A third parameter may include identifying the TLD of the DNS queries/NXDOMAIN responses such as “.com” as indicated in Table 1. Identifying the TLD may provide a means to determine whether the DGA is generating the DNS queries/NXDOMAIN responses. Although a DGA may generate DNS queries/NXDOMAIN responses that have varying TLDs such as “.com,” “.org,” “.gov,” “.edu,” etc., it may be more likely that the DGA generates random strings of characters with the same TLD.

A fourth parameter the DGA detection and perplexity logic 120 may determine may include the perplexity bucket where domain names with a similar range of perplexity scores may be grouped into the same family. Again, using the entries in Table 1 above, the DGA detection and perplexity logic 120 may calculate that the first entry (e.g., “kdlsghdakjgfskdh.com”) has a perplexity score of 200, the second entry (e.g., “lsdkfjggasldkfjjgs.com”) has a perplexity score of 189, the third entry (e.g., “ienffoakwitnvuys.com”) has a perplexity score of 154, and the fourth entry (e.g., “nciisdoejehanqpsl.com”) has a perplexity score of 199. Further, in one example, the perplexity buckets may include ranges as follows: [140, 160), [160, 180) and [180, 200). Thus, the first, second, and fourth entries in Table 1 would be placed in the perplexity bucket with the range [180, 200) and the third entry would be placed in the perplexity bucket with the range [140, 160). This may indicate that the third entry is less likely to belong to the same group or family of domain names that were generated by the DGA. Further, any other domain name such as google.com may, for example, have a perplexity score of 50, and would therefore not be counted as belonging to any group or family that the DGA detection and perplexity logic 120 identifies. In this manner, the DGA detection and perplexity logic 120 does not sweep in most if not all resolving DNS queries.

The DGA detection and perplexity logic 120 may utilize any number of parameters in determining whether the domain names associated with the DNS queries/NXDOMAIN responses are generated by the DGA, and any weight may be applied to a given parameters. Further, in one example, the weighting of the parameters may be user-definable or otherwise adjustable in order to allow for fine tuning of the DGA detection and perplexity logic 120. With the above example of four parameters, the DGA detection and perplexity logic 120 may then generate a vector such as, for example, [16, 3, .com, [180, 200)] where the first parameter is the number of characters in the string of characters in the second level domain, 3 is the time interval (e.g., in seconds) between receipt of the DNS queries/NXDOMAIN responses, .com is the TLD of the DNS queries/NXDOMAIN responses, and [180, 200) is the perplexity score range. This vector information may be stored in any data storage device of the DNS server 102, the analysis server 114, the client device 122, or other computing device to which the DGA detection and perplexity logic 120 has access. In one example, the vector information may be stored in the memory 118 of the analysis server, the DGA cache 110 of the DNS server 102, the main cache 112 of the DNS server 102, and combinations thereof. The vectors acts as keys used to recognize entries or records stored in the DGA cache 110 that are similar as described in more detail below. Further, in one example, the number of parameters included within the vector may be user-definable or otherwise adjustable to allow for more or less specificity in making a determination as to which domain names of the DNS queries/NXDOMAIN responses should be grouped into families. In one example, a single statistic defining a single parameter may create an effective vector. However, the vector may be generated based on any number of parameters. In one example, the vector may be generated based on 1 to 20 parameters.

With the vector parameters determined in order to create a vector, the DGA detection and perplexity logic 120 may be fed a number of domain names associated with the DNS queries/NXDOMAIN responses stored in the main cache 112 and may translate those domain names into a vector. For example, a subsequent domain name “uthsneufhayqlosn.com” of a subsequent DNS query/NXDOMAIN response may be calculated by the DGA detection and perplexity logic 120 to have a vector of [16, 3, .com, 182]. Continuing with the example above, the subsequent domain name “uthsneufhayqlosn.com” of the subsequent DNS query/NXDOMAIN response may be included with the first, second, and fourth entries in Table 1 and would be placed in the perplexity bucket with the range [180, 200). Thus, the subsequent domain name may be identified as being included in the same family as the first, second, and fourth entries in Table 1 as being at least potentially generated by the same DGA. In one example, as subsequent domain names are added to the same perplexity bucket and resulting family of domain names, the DGA detection and perplexity logic 120 may store those families in, for example, the DGA cache 110 at least temporarily.

Further, as subsequent domain names are added to the same perplexity bucket and resulting family of domain names, the DGA detection and perplexity logic 120 may increment a count of the members of the families. After a family of domain names reach a threshold number of DNS queries/NXDOMAIN responses per client such as, for example, a threshold of 10 DNS queries/NXDOMAIN responses, the family of domain names may be identified as having been generated by the same DGA. As a result, the DGA detection and perplexity logic 120 may, in a reactive manner, block any additional DNS queries/NXDOMAIN responses that have a vector of the family without allowing the DNS resolver component 106 to resolve those DNS queries. Given that a DGA family may be determined based on a DNS question alone, aforementioned vector used to fingerprint a DNS query may be constructed. This vector may be used to describe a method to group analogous queries to a DGA family. Below is described how this vector is used to block queries.

DNS Query Flow from Detection to Enforcement

With regard to the specific method by which query flow detection and enforcement may be performed, the DNS queries/NXDOMAIN responses are categorized in their respective families as described herein. In one example, this categorization in to families of DNS queries/NXDOMAIN responses may be performed by the DNS server 102 and analysis server 114 prior to an recursive upstream. The DNS queries may flag as identifying as being DNS queries generated by a DGA and a number of policy enforcements may be activated.

The DGA detection and perplexity logic 120 may perform an RBL cache 108 construction. Further, the DGA detection and perplexity logic 120 may perform a lookup in the RBL cache 108 for the blocklisted client device(s) 122 and/or DNS queries from the client device(s) 122. If the DGA queries are determined to belong to a family of DGA-generated DNS queries, then the DNS queries are refused, the DGA session is prevented, and the DNS resolver component 106 does not resolve those DNS queries.

If the DGA queries are not determined to belong to a family of DGA-generated DNS queries, then the recursive DNS resolution process is continued. Before the DNS server 102 returns a DNS packet to the client device 122, the DGA cache 110 may be updated. At this point in the process C2 communication may have already occurred.

The DNS server 102 may then perform DGA cache 110 key construction and lookup processes. This may include applying a series of DGA filters including a DGA allow filter(s) and a DGA detect filter(s). The allow filters may include conditions to skip the DNS query from being a candidate DGA, while the detect filters assist in including a DNS query as a candidate DGA. The DGA allow filter(s) may perform a number of filter processes such as, for example, not processing domains with subdomains, not processing domains that are popular (e.g., whitelisted domains) and have analyst content categorization, and not processing where the query response code (rcode) is something other than NXDOMAIN. The detect filter(s) may be included as part of the DGA detection and perplexity logic 120 and may perform a number of filter processes such as, for example, computing the perplexity of the label below the public suffix of a domain name within a DNS request, and if that perplexity is within a threshold, not processing the DNS request. For example, if qvekljrler.xyz were the domain name and the perplexity value assigned to the label where between a lower bound and an upper bound (lower_bound<perplexity(qvekljrler)<upper_bound), the DNS request may not be processed.

The DNS server 102 performing the DGA cache 110 key construction and lookup processes may further include creating a DGA cache key, updating the DGA data field hook if a key already exists in the cache (e.g., LRU cache) and otherwise creating the DGA cache key if the key does not already exists. This process may also include comparing updated data fields to pre-determined thresholds, and, if updated data fields are within thresholds, an RBL cache 108 entry may be created/updated. For example, if the qname fingerprint bits are greater than, for example, 5 (e.g., qname fingerprint bits>5) and the count is also greater than, for example, 5 (e.g., count>5) and the absolute value of the difference between the qname fingerprint bits and the count is less than, for example, 1 (e.g., abs(popcount(qname fingerprint bits)−count)<1), then a DGA session for the client device 122 may be performed where popcount returns the number of non-zero bits to an unsigned integer. Otherwise, the DGA session for the client device 122 may not be performed.

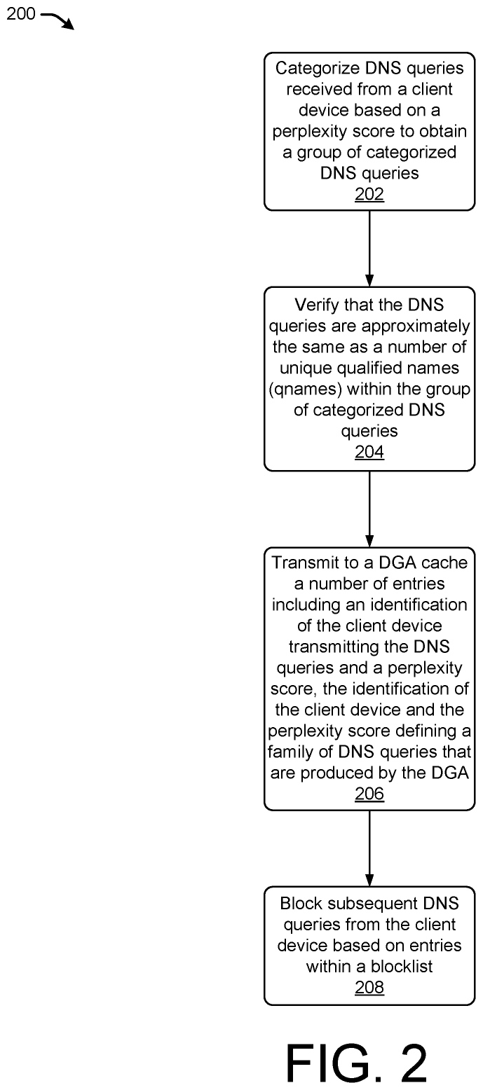

FIG. 2 illustrates a flow diagram of an example method 200 of detecting a domain generation algorithm (DGA), according to an example of the principles described herein. The method 200 may be performed by the DNS resolver component 106, the main cache 112, the RBL cache 108, and/or the DGA cache 110 of the DNS server, the DGA detection and perplexity logic 120 of the analysis server 114, and combinations thereof. The method 200 may include, at 202, categorizing a plurality of domain name system (DNS) queries received from a client device 122 based on a perplexity score to obtain a group of categorized DNS queries. At 204, the method 200 may include verifying that the DNS queries correspond to a number of unique qnames are approximately the same as a number of unique qnames within the group of categorized DNS queries. The DGA cache 110 may transmit a number of entries including an identification of the client device 122 transmitting the DNS queries and a perplexity score at 206. The identification of the client device 122 and the perplexity score define a family of DNS queries that are produced by the DGA. At 208, any subsequent DNS queries from the client device 122 may be blocked based on entries within the blocklist 130.

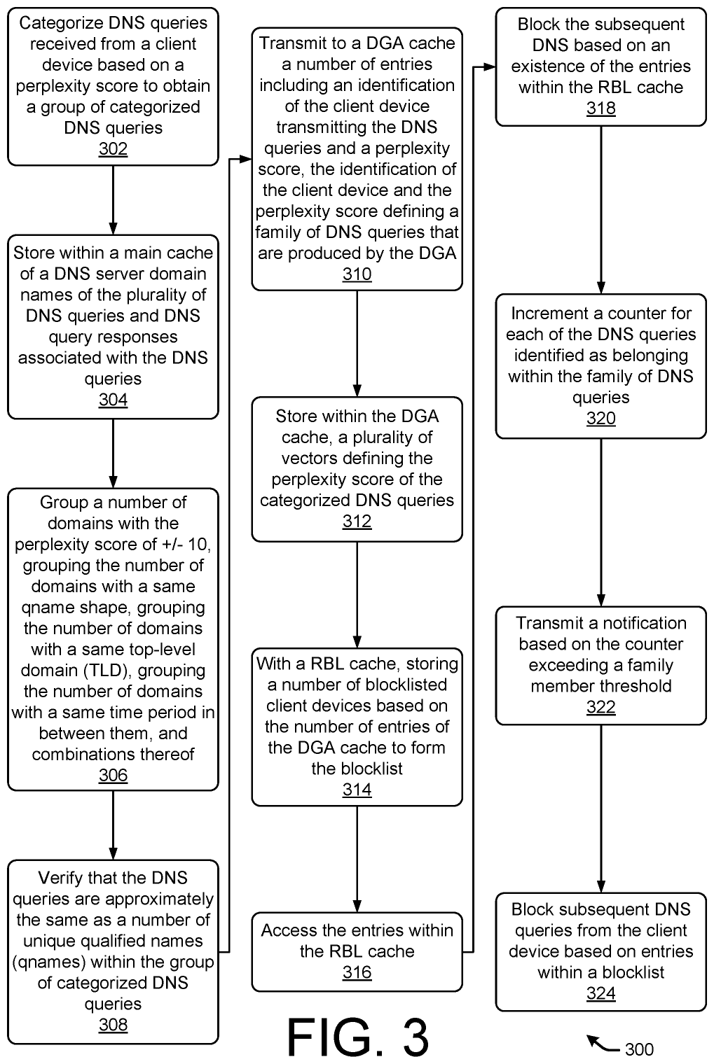

FIG. 3 illustrates a flow diagram of an example method 300 of detecting a domain generation algorithm (DGA), according to an example of the principles described herein. The method 300 may be performed by the DNS resolver component 106, the main cache 112, the RBL cache 108, and/or the DGA cache 110 of the DNS server, the DGA detection and perplexity logic 120 of the analysis server 114, and combinations thereof. The method 300 may include, at 202, categorizing a plurality of DNS queries received from a client device 122 based on a perplexity score to obtain a group of categorized DNS queries. As described herein, the perplexity score of a string of characters within a domain name of a first DNS query of the plurality of DNS queries may be computed based at least in part on a Markov model comparing two characters of the string of characters to another character of the string of characters. The plurality of DNS queries within the family of DNS queries may include the perplexity score within a threshold range of at least one other DNS query within the family of DNS queries.

At 304, the method 300 may further include storing within the main cache 112 of a DNS server 102 domain names of the plurality of DNS queries and DNS query responses associated with the plurality of DNS queries. With relation to 302, categorizing of the plurality of DNS queries received from the client device based on the perplexity score may include, at 306, grouping a number of domains with the perplexity score of, for example, +/−10, grouping the number of domains with a same qname shape, grouping the number of domains with a same top-level domain (TLD), grouping the number of domains with a same time period in between them, grouping the number of domains with other similar values of a number of other parameters, and combinations thereof. Although the number of domains with the perplexity score of, for example, +/−10 may be grouped together in one example, the perplexity buckets may include any range of values.

At 308, the method 300 may include verifying that the DNS queries correspond to a number of unique qnames are approximately the same as the number of unique qnames within the group of categorized DNS queries. The DGA cache 110 may transmit a number of entries including an identification of the client device 122 transmitting the DNS queries and a perplexity score at 310. The transmission to the DGA cache 110 the number of entries including the identification of the client device transmitting the DNS queries and the perplexity score may further include, at 312, storing within the DGA cache 110, a plurality of vectors defining the perplexity score of the categorized DNS queries.

At 314, with the RBL cache 108, a number of blocklisted client devices may be stored based on the number of entries of the DGA cache to form the blocklist. The blocking of the subsequent DNS queries from the client device 122 may include, at 316, accessing the entries within the RBL cache 108, and blocking, at 318, the subsequent DNS queries based on an existence of the entries within the RBL cache 108.

At 320, a counter may be incremented for each of the DNS queries identified as belonging within the family of DNS queries, and, at 322, a notification may be transmitted based on the counter exceeding a family member threshold. At 324, any subsequent DNS queries from the client device 122 may be blocked based on entries within the blocklist 130. Blocking the subsequent DNS queries may include blocking the subsequent DNS queries that fall within the family of DNS queries.

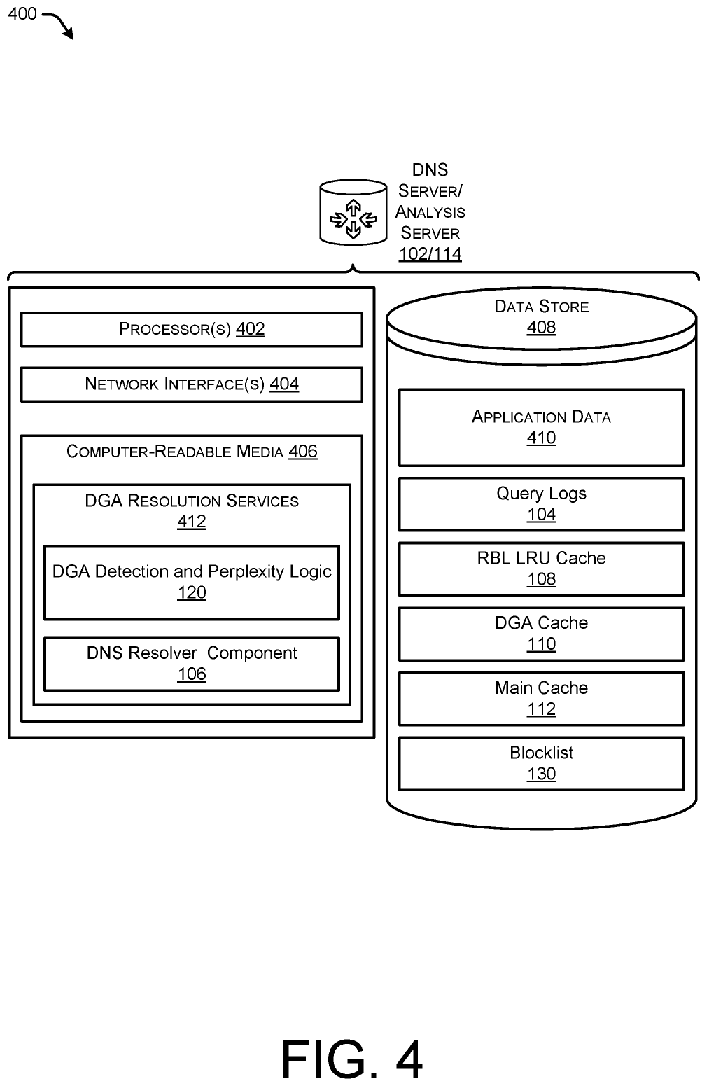

FIG. 4 is a component diagram 400 of example components of a DNS server 102 and/or analysis server 114 including DGA resolution services, according to an example of the principles described herein. As illustrated, the DNS server 102 and/or analysis server 114 may include one or more hardware processor(s) 402 configured to execute one or more stored instructions. The processor(s) 402 may include one or more cores. Further, the DNS server 102 and/or analysis server 114 may include one or more network interfaces 404 configured to provide communications between the DNS server 102 and/or analysis server 114 and other devices, such as devices associated with the system architecture of FIG. 1 including the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, and/or other systems or devices associated with the DNS server 102 and/or analysis server 114 and/or remote from the DNS server 102 and/or analysis server 114. The network interfaces 404 may include devices configured to couple to personal area networks (PANs), wired and wireless local area networks (LANs), wired and wireless wide area networks (WANs), and so forth. For example, the network interfaces 404 may include devices compatible with the client devices 122, network 124, the DNS resolver component 106, the RBL cache 108, the DGA cache 110 and/or other systems or devices associated with the DNS server 102 and/or analysis server 114.

The DNS server 102 and/or analysis server 114 may also include computer-readable media 406 that stores various executable components (e.g., software-based components, firmware-based components, etc.). In one example, the computer-readable media 406 may include, for example, working memory, random access memory (RAM), read only memory (ROM), and other forms of persistent, non-persistent, volatile, non-volatile, and other types of data storage. In addition to various components discussed herein, the computer-readable media 406 may further store components to implement functionality described herein. While not illustrated, the computer-readable media 406 may store one or more operating systems utilized to control the operation of the one or more devices that comprise the DNS server 102 and/or analysis server 114. According to one example, the operating system comprises the LINUX operating system. According to another example, the operating system(s) comprise the WINDOWS SERVER operating system from MICROSOFT Corporation of Redmond, Washington. According to further examples, the operating system(s) may comprise the UNIX operating system or one of its variants. It may be appreciated that other operating systems may also be utilized.

Additionally, the DNS server 102 and/or analysis server 114 may include a data store 408 which may comprise one, or multiple, repositories or other storage locations for persistently storing and managing collections of data such as databases, simple files, binary, and/or any other data. The data store 408 may include one or more storage locations that may be managed by one or more database management systems. The data store 408 may store, for example, application data 410 defining computer-executable code utilized by the processor 402 to execute a number of applications associated with the systems and methods described herein. Further, the application data 410 may include data relating to user preferences associated with the DGA detection and perplexity logic 120, the DNS resolver component 106, and any software or firmware executed on the DNS server 102, the query logs 104, the RBL cache 108, the DGA cache 110, the main cache 112, the analysis server 114, the processor 116, the memory 118, the client device 122, the network (e.g., Internet) 124, the web services 126, the blacklist query server 128, the blocklist 130, and other data that may be used by the applications to detect DGAs and block DNS queries are described herein.

The computer-readable media 406 may store portions, or components, of DGA resolution services 412. For instance, the DGA resolution services 412 of the computer-readable media 406 may include the DGA detection and perplexity logic 120 and the DNS resolver component 106 to, when executed by the processor(s) 402, perform DGA detection and domain name blocking according the systems and methods described herein. The DGA resolution services 412 may include all or a portion of the executable code associated with the DNS server 102 and/or analysis server 114 and may be executed to bring about the functionality of the DNS server 102 and/or analysis server 114 as described herein.

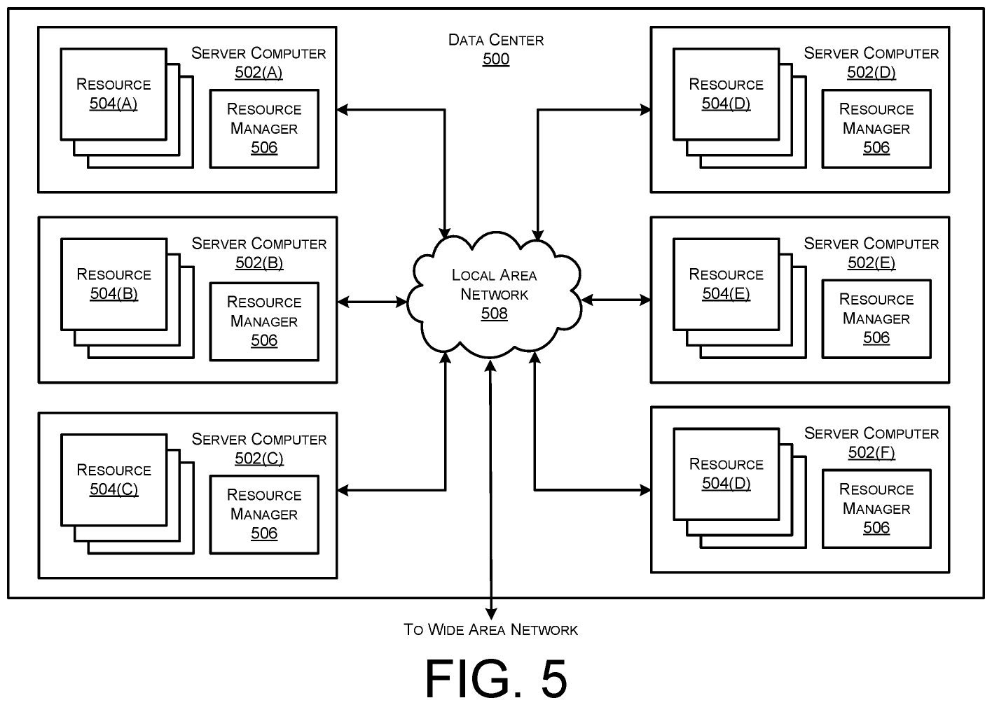

FIG. 5 illustrates a computing system diagram illustrating a configuration for a data center 500 that may be utilized to implement aspects of the technologies disclosed herein. The example data center 500 shown in FIG. 5 includes several server computers 502A-502F (which might be referred to herein singularly as “a server computer 502” or in the plural as “the server computers 502) for providing computing resources. In some examples, the resources and/or server computers 502 may include, or correspond to, any type of networked device described herein. Although described as servers, the server computers 502 may comprise any type of networked device, such as servers, switches, routers, hubs, bridges, gateways, modems, repeaters, access points, etc.

The server computers 502 may be standard tower, rack-mount, or blade server computers configured appropriately for providing computing resources. In some examples, the server computers 502 may provide computing resources 504 including data processing resources such as VM instances or hardware computing systems, database clusters, computing clusters, storage clusters, data storage resources, database resources, networking resources, virtual private networks (VPNs), and others. Some of the server computers 502 may also be configured to execute a resource manager 506 capable of instantiating and/or managing the computing resources. In the case of VM instances, for example, the resource manager 506 may be a hypervisor or another type of program configured to enable the execution of multiple VM instances on a single server computer 502. Server computers 502 in the data center 500 may also be configured to provide network services and other types of services.

In the example data center 500 shown in FIG. 5, an appropriate LAN 508 is also utilized to interconnect the server computers 502A-502F. It may be appreciated that the configuration and network topology described herein has been greatly simplified and that many more computing systems, software components, networks, and networking devices may be utilized to interconnect the various computing systems disclosed herein and to provide the functionality described above. Appropriate load balancing devices or other types of network infrastructure components may also be utilized for balancing a load between data centers 500, between each of the server computers 502A-502F in each data center 500, and, potentially, between computing resources in each of the server computers 502. It may be appreciated that the configuration of the data center 500 described with reference to FIG. 5 is merely illustrative and that other implementations may be utilized.

In some examples, the server computers 502 and or the computing resources 504 may each execute/host one or more tenant containers and/or virtual machines to perform techniques described herein.

In some instances, the data center 500 may provide computing resources, like tenant containers, VM instances, VPN instances, and storage, on a permanent or an as-needed basis. Among other types of functionality, the computing resources provided by a cloud computing network may be utilized to implement the various services and techniques described herein. The computing resources 504 provided by the cloud computing network may include various types of computing resources, such as data processing resources like tenant containers and VM instances, data storage resources, networking resources, data communication resources, network services, VPN instances, and the like.

Each type of computing resource 504 provided by the cloud computing network may be general-purpose or may be available in a number of specific configurations. For example, data processing resources may be available as physical computers or VM instances in a number of different configurations. The VM instances may be configured to execute applications, including web servers, application servers, media servers, database servers, some or all of the network services described above, and/or other types of programs. Data storage resources may include file storage devices, block storage devices, and the like. The cloud computing network may also be configured to provide other types of computing resources 504 not mentioned specifically herein.

The computing resources 504 provided by a cloud computing network may be enabled in one example by one or more data centers 500 (which might be referred to herein singularly as “a data center 500” or in the plural as “the data centers 500). The data centers 500 are facilities utilized to house and operate computer systems and associated components. The data centers 500 typically include redundant and backup power, communications, cooling, and security systems. The data centers 500 may also be located in geographically disparate locations. One illustrative example for a data center 500 that may be utilized to implement the technologies disclosed herein is described herein with regard to, for example, FIGS. 1 through 4.

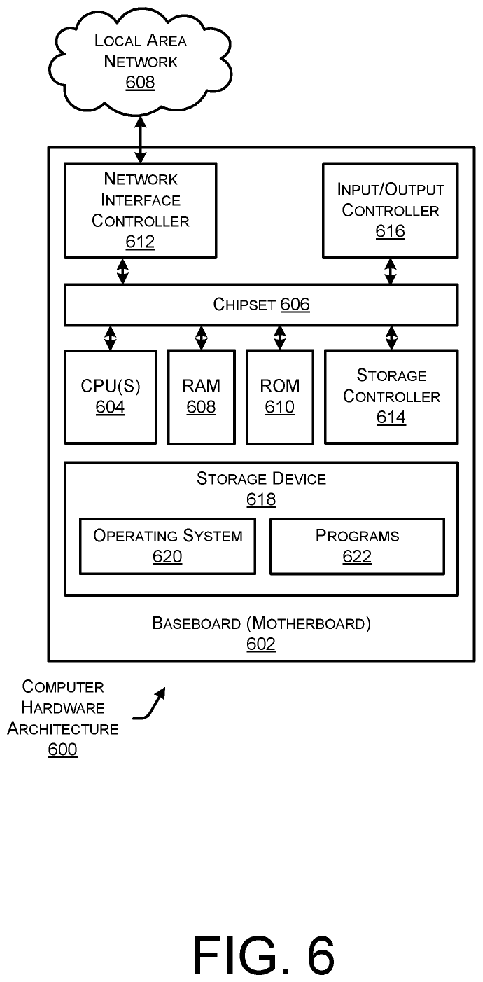

FIG. 6 illustrates a computer architecture diagram showing an example computer hardware architecture 600 for implementing a computing device that may be utilized to implement aspects of the various technologies presented herein. The computer hardware architecture 600 shown in FIG. 6 illustrates the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, and/or other systems or devices associated with the system 100 and/or remote from the system 100, a workstation, a desktop computer, a laptop, a tablet, a network appliance, an e-reader, a smartphone, or other computing device, and may be utilized to execute any of the software components described herein. The computer 600 may, in some examples, correspond to a network device (e.g., the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, and/or the blocklist 130 (and associated devices) described herein, and may comprise networked devices such as servers, switches, routers, hubs, bridges, gateways, modems, repeaters, access points, etc.

The computer 600 includes a baseboard 602, or “motherboard,” which is a printed circuit board to which a multitude of components or devices may be connected by way of a system bus or other electrical communication paths. In one illustrative configuration, one or more central processing units (CPUs) 604 operate in conjunction with a chipset 606. The CPUs 604 may be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements may be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 may provide an interface to a RAM 608, used as the main memory in the computer 600. The chipset 606 may further provide an interface to a computer-readable storage medium such as a read-only memory (ROM) 610 or non-volatile RAM (NVRAM) for storing basic routines that help to startup the computer 600 and to transfer information between the various components and devices. The ROM 610 or NVRAM may also store other software components necessary for the operation of the computer 600 in accordance with the configurations described herein.

The computer 600 may operate in a networked environment using logical connections to remote computing devices and computer systems through a network, such as the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, among other devices. The chipset 606 may include functionality for providing network connectivity through a Network Interface Controller (NIC) 612, such as a gigabit Ethernet adapter. The NIC 612 is capable of connecting the computer 600 to other computing devices within the system 100 and external to the system 100. It may be appreciated that multiple NICs 612 may be present in the computer 600, connecting the computer to other types of networks and remote computer systems. In some examples, the NIC 612 may be configured to perform at least some of the techniques described herein, such as packet redirects and/or other techniques described herein.

The computer 600 may be connected to a storage device 618 that provides non-volatile storage for the computer. The storage device 618 may store an operating system 620, programs 622 (e.g., any computer-readable and/or computer-executable code described herein), and data, which have been described in greater detail herein. The storage device 618 may be connected to the computer 600 through a storage controller 614 connected to the chipset 606. The storage device 618 may consist of one or more physical storage units. The storage controller 614 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computer 600 may store data on the storage device 618 by transforming the physical state of the physical storage units to reflect the information being stored. The specific transformation of physical state may depend on various factors, in different examples of this description. Examples of such factors may include, but are not limited to, the technology used to implement the physical storage units, whether the storage device 618 is characterized as primary or secondary storage, and the like.

For example, the computer 600 may store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 may further read information from the storage device 618 by detecting the physical states or characteristics of one or more particular locations within the physical storage units.

In addition to the storage device 618 described above, the computer 600 may have access to other computer-readable storage media to store and retrieve information, such as program modules, data structures, or other data. It may be appreciated by those skilled in the art that computer-readable storage media is any available media that provides for the non-transitory storage of data and that may be accessed by the computer 600. In some examples, the operations performed by the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, and or any components included therein, may be supported by one or more devices similar to computer 600. Stated otherwise, some or all of the operations performed by the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, and or any components included therein, may be performed by one or more computer devices operating in a cloud-based arrangement.

By way of example, and not limitation, computer-readable storage media may include volatile and non-volatile, removable and non-removable media implemented in any method or technology. Computer-readable storage media includes, but is not limited to, RAM, ROM, erasable programmable ROM (EPROM), electrically-erasable programmable ROM (EEPROM), flash memory or other solid-state memory technology, compact disc ROM (CD-ROM), digital versatile disk (DVD), high definition DVD (HD-DVD), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 618 may store an operating system 620 utilized to control the operation of the computer 600. According to one example, the operating system 620 comprises the LINUX operating system. According to another example, the operating system comprises the WINDOWS® SERVER operating system from MICROSOFT Corporation of Redmond, Washington. According to further examples, the operating system may comprise the UNIX operating system or one of its variants. It may be appreciated that other operating systems may also be utilized. The storage device 618 may store other system or application programs and data utilized by the computer 600.

In one example, the storage device 618 or other computer-readable storage media is encoded with computer-executable instructions which, when loaded into the computer 600, transform the computer from a general-purpose computing system into a special-purpose computer capable of implementing the examples described herein. These computer-executable instructions transform the computer 600 by specifying how the CPUs 604 transition between states, as described above. According to one example, the computer 600 has access to computer-readable storage media storing computer-executable instructions which, when executed by the computer 600, perform the various processes described above with regard to FIGS. 1 through 5. The computer 600 may also include computer-readable storage media having instructions stored thereupon for performing any of the other computer-implemented operations described herein.

The computer 600 may also include one or more input/output controllers 616 for receiving and processing input from a number of input devices, such as a keyboard, a mouse, a touchpad, a touch screen, an electronic stylus, or other type of input device. Similarly, an input/output controller 616 may provide output to a display, such as a computer monitor, a flat-panel display, a digital projector, a printer, or other type of output device. It will be appreciated that the computer 600 might not include all of the components shown in FIG. 6, may include other components that are not explicitly shown in FIG. 6, or might utilize an architecture completely different than that shown in FIG. 6.

As described herein, the computer 600 may comprise one or more of the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, and/or other systems or devices associated with the system 100 and/or remote from the system 100. The computer 600 may include one or more hardware processor(s) such as the CPUs 604 configured to execute one or more stored instructions. The CPUs 604 may comprise one or more cores. Further, the computer 600 may include one or more network interfaces configured to provide communications between the computer 600 and other devices, such as the communications described herein as being performed by the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130, and other devices described herein. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for the DNS server 102, the query logs 104, the DNS resolver component 106, the RBL cache 108, the DGA cache 110, the main cache 112, the analysis server 114, the processor 116, the memory 118, the DGA detection and perplexity logic 120, the client device 122, the network (e.g., Internet) 124, the web services 126, the blacklist query server 128, the blocklist 130 as described herein. The programs 622 may enable the devices described herein to perform various operations.

### CONCLUSION

The examples described herein provide for systems and methods for detecting the DGAs in the DNS resolver by efficiently identifying client IP NXDOMAIN sessions made of (1) qnames with similar lexical perplexity, (2) qname shape (number of labels and size of DNS labels), and (3) public suffixes, and verify that the number of queries is roughly the same as the number of unique qnames. The client device along with the qname shape and perplexity score may be sent to the real-time blocklist cache and subsequent queries are blocked (some of which may not be NXDOMAIN) providing the ability to block resolving C2 communication.

With the above-described systems and methods, DGA-generated DNS queries may be identified and blocked without addition of significant hardware or software to the system.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure, and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A method of detecting a domain generation algorithm (DGA), comprising:
categorizing a plurality of domain name system (DNS) queries received from a client device based on a perplexity score to obtain a group of categorized DNS queries;
verifying that the DNS queries correspond to a number of unique qualified names (qnames) within the group of categorized DNS queries;
transmitting to a DGA cache a number of entries including an identification of the client device transmitting the DNS queries and a perplexity score, the identification of the client device and the perplexity score defining a family of DNS queries that are produced by the DGA; and
blocking subsequent DNS queries from the client device based on entries within a blocklist.

2. The method of claim 1, wherein the perplexity score of a string of characters within a domain name of a first DNS query of the plurality of DNS queries is computed based at least in part on a Markov model comparing two characters of the string of characters to another character of the string of characters,
wherein the plurality of DNS queries within the family of DNS queries include the perplexity score within a threshold range of at least one other DNS query within the family of DNS queries.

3. The method of claim 1, further comprising storing within a main cache of a DNS server domain names of the plurality of DNS queries and DNS query responses associated with the plurality of DNS queries.

4. The method of claim 1, wherein the transmitting to the DGA cache the number of entries including the identification of the client device transmitting the DNS queries and the perplexity score further comprises:
storing within the DGA cache, a plurality of vectors defining the perplexity score of the categorized DNS queries;
incrementing a counter for each of the DNS queries identified as belonging within the family of DNS queries; and
transmitting a notification based on the counter exceeding a family member threshold.

5. The method of claim 1, further comprising, with a real-time blocklist (RBL) cache, storing a number of blocklisted client devices based on the number of entries of the DGA cache to form the blocklist,
wherein the blocking of the subsequent DNS queries from the client device comprises:
accessing the entries within the RBL cache; and
blocking the subsequent DNS queries based on an existence of the entries within the RBL cache.

6. The method of claim 1, wherein blocking the subsequent DNS queries comprises blocking the subsequent DNS queries that fall within the family of DNS queries.

7. The method of claim 1, wherein the categorizing of the plurality of DNS queries received from the client device based on the perplexity score includes grouping a number of domains with the perplexity score of +/−10, grouping the number of domains with a same qname shape, grouping the number of domains with a same top-level domain (TLD), grouping the number of domains with a same time period in between them, and combinations thereof.

8. A non-transitory computer-readable medium storing instructions that, when executed, causes a processor to perform operations, comprising:
categorizing a plurality of DNS queries received from a client device based on a perplexity score to obtain a group of categorized DNS queries;
verifying that the DNS queries correspond to a number of unique qualified names (qnames) within the group of categorized DNS queries;
transmitting to a DGA cache a number of entries including an identification of the client device transmitting the DNS queries and a perplexity score, the identification of the client device and the perplexity score defining a family of DNS queries that are produced by the DGA; and
blocking subsequent DNS queries from the client device based on entries within a blocklist.

9. The non-transitory computer-readable medium of claim 8, wherein the perplexity score of a string of characters within a domain name of a first DNS query of the plurality of DNS queries is computed based at least in part on a Markov model comparing two characters of the string of characters to another character of the string of characters,
wherein the plurality of DNS queries within the family of DNS queries include the perplexity score within a threshold range of at least one other DNS query within the family of DNS queries.

10. The non-transitory computer-readable medium of claim 8, the operations further comprising storing within a main cache of a DNS server domain names of the plurality of DNS queries and DNS query responses associated with the plurality of DNS queries.

11. The non-transitory computer-readable medium of claim 8, wherein the transmitting to the DGA cache the number of entries including the identification of the client device transmitting the DNS queries and the perplexity score further comprises:
storing within the DGA cache, a plurality of vectors defining the perplexity score of the categorized DNS queries;
incrementing a counter for each of the DNS queries identified as belonging within the family of DNS queries; and
transmitting a notification based on the counter exceeding a family member threshold.

12. The non-transitory computer-readable medium of claim 8, the operations further comprising, with a real-time blocklist (RBL) cache, storing a number of blocklisted client devices based on the entries of the DGA cache to form the blocklist,
wherein the blocking of the subsequent DNS queries from the client device comprises:
accessing the entries within the RBL cache; and
blocking the subsequent DNS queries based on an existence of the entries within the RBL cache.

13. The non-transitory computer-readable medium of claim 8, wherein blocking the subsequent DNS queries comprises blocking subsequent DNS queries that fall within the family of DNS queries.

14. The non-transitory computer-readable medium of claim 8, wherein the categorizing of the plurality of DNS queries received from the client device based on the perplexity score includes grouping a number of domains with the perplexity score of +/−10, grouping the number of domains with a same qname shape, grouping the number of domains with a same top-level domain (TLD), grouping the number of domains with a same time period in between them, and combinations thereof.

15. A system comprising:
a processor; and
a non-transitory computer-readable media storing instructions that, when executed by the processor, causes the processor to perform operations comprising:
categorizing a plurality of DNS queries received from a client device based on a score to obtain a group of categorized DNS queries;
verifying that the DNS queries correspond to a number of unique qualified names (qnames) within the group of categorized DNS queries;
transmitting to a DGA cache a number of entries including an identification of the client device transmitting the DNS queries and a perplexity score, the identification of the client device and the perplexity score defining a family of DNS queries that are produced by the DGA; and
blocking subsequent DNS queries from the client device based on entries within a blocklist.

16. The system of claim 15, wherein the perplexity score of a string of characters within a domain name of a first DNS query of the plurality of DNS queries is computed based at least in part on a Markov model comparing two characters of the string of characters to another character of the string of characters,
wherein the plurality of DNS queries within the family of DNS queries include the perplexity score within a threshold range of at least one other DNS query within the family of DNS queries.

17. The system of claim 15, the operations further comprising storing within a main cache of a DNS server domain names of the plurality of DNS queries and DNS query responses associated with the plurality of DNS queries.

18. The system of claim 15, wherein the transmitting to the DGA cache the number of entries including the identification of the client device transmitting the DNS queries and the perplexity score further comprises:
storing within the DGA cache, a plurality of vectors defining the perplexity score of the categorized DNS queries;
incrementing a counter for each of the DNS queries identified as belonging within the family of DNS queries; and
transmitting a notification based on the counter exceeding a family member threshold.

19. The system of claim 15, the operations further comprising, with a real-time blocklist (RBL) cache, storing a number of blocklisted client devices based on the entries of the DGA cache to form the blocklist,
wherein the blocking of the subsequent DNS queries from the client device comprises:
accessing the entries within the RBL cache; and
blocking the subsequent DNS queries based on an existence of the entries within the RBL cache.

20. The system of claim 15, wherein the categorizing of the plurality of DNS queries received from the client device based on the perplexity score includes grouping a number of domains with the perplexity score of +/−10, grouping the number of domains with a same qname shape, grouping the number of domains with a same top-level domain (TLD), grouping the number of domains with a same time period in between them, and combinations thereof.
